(19) United States
(12) Patent Application Publication
(10) Pub. No.: US 2012/0117129 A1
(43) Pub. Date: May 10, 2012

(54) DATA DISTRIBUTION SYSTEM AND METHOD THEREOF

(76) Inventors: Chia-Chin Wang, Taipei City (TW); Yung-Tsai Wang, Taoyuan County (TW)

(21) Appl. No.: 12/939,169

(22) Filed: Nov. 4, 2010

(51) Int. Cl. G06F 17/30

(52) U.S. Cl. 707/827; 707/E17.01

(57) ABSTRACT

A data distribution system includes a processor, a storage device, a display device and a network coupling device. The display device displays information of the digital data or relevant web resources regarding location-based services. The network coupling device allows at least one external device to couple to the processor to access the digital data or relevant web resources. Consequently, the data distribution system is able to inform the user availability of location-based services and allows user to access or interact with location-based services.

### BACKGROUND OF THE INVENTION

1. Field of the Invention

The present invention is related to a data distribution system, and more particularly, to a data distribution system that informs the user the availability of locally-available services.

2. Description of the Prior Art

Digital display technology has allowed information (e.g. audio or video etc.) to be distributed in public areas such as shopping malls, corporate lobbies, and general waiting areas. Current technologies, however, usually only provide one-way communication; that is, viewers in the public space have no simple way to respond to the distributed information, or request for further details. It is both the interest of the information provider and of the public to conceive a method to conveniently enable two-way communication.

Location-based services utilize location information to provide the public with relevant information. Mobile devices, such as mobile phones or smart phones, allow users to communicate with the location-based services. However, the user must knowingly “tune-in” by pulling out the mobile device to check if any location-based services are available. It is not only difficult for a user to know whether location-based service or information is indeed provided for at his point of interest, but also inconvenient for the user to frequently/continuously check the mobile device to see the availability of location-based services.

### SUMMARY OF THE INVENTION

The present invention discloses a data distribution system for distributing digital data. The data distribution system comprises a processor, a storage device, a display device and a network coupling device. The storage device is coupled to the processor for storing a media file and the digital data. The display device is coupled to the processor, for playing back the media file. The network coupling device is coupled to the processor, for allowing at least one external device to connect to the processor to access the digital data.

The present invention further discloses a data distribution method for distributing digital data from a data distribution system. The data distribution system comprises a processor, a storage device, a display device, and a network coupling device. The storage device is coupled to the processor for storing a media file and digital data. The display device and the network coupling device are coupled to the processor. The method comprises playing back the media file on the display device for informing an availability of the digital data; and at least one external device coupling to the processor via the network coupling device for accessing the digital data from the storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustration of the data distribution system 10 according to an embodiment of the present invention.

FIG. 2 is a flow chart illustrating a data distribution method utilizing data distribution system 10 according to an embodiment of the present invention.

FIG. 3 is a flow chart illustrating user interacting with the data distribution system 10 according to an embodiment of the present invention.

FIG. 4 is a diagram illustrating a practical embodiment utilizing the data distribution system 10 of the present invention.

### DETAILED DESCRIPTION

One of the objectives of the present invention is to provide a data distribution system that informs the user the availability of local services or events, and allows user to access or interact with local services. The data distribution system also updates the content notifying the availability of local services.

A real-life scenario of the system configuration would consist of a computer which includes a hard disk drive and connected to a large screen. The computer would also be attached to a WiFi access point (the “coupling device”) so that an external device such as a mobile phone with WiFi capability can connect to the computer via the access point to download information available on the local hard disk. The large screen would play advertising information to notify the user that information is available for download via WiFi, and provide steps on how to connect user's phone to access the information.

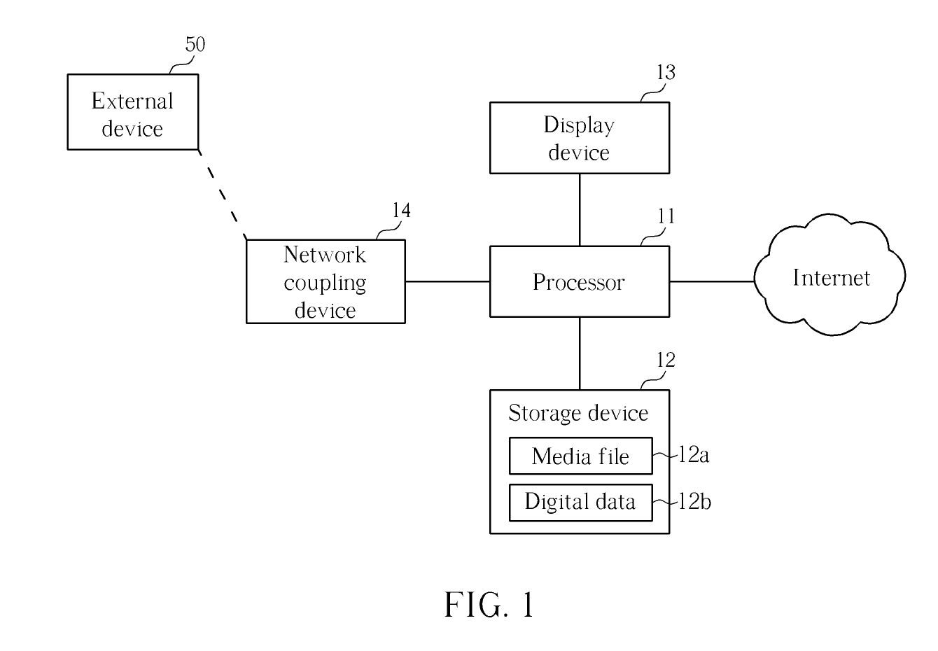

Please refer to FIG. 1. FIG. 1 is a diagram illustration of a data distribution system 10 according to an embodiment of the present invention. The data distribution system 10 comprises a processor 11, a storage device 12, a display device 13 and a network coupling device 14. The storage device 12, the display device 13 and the network coupling device 14 are coupled to the processor 11.

The storage device 12 stores electronic data; in the present embodiment, the storage device 12 stores at least one media file 12a and digital data 12b. The display device 13 plays back and displays the media file 12a. In other embodiments of the present invention, the storage device 12 may be a local drive, coupled to the processor 11 via an electrical data bus or intranet.

The media file 12a is related to the digital data 12b such that the media file 12a, when played back, announces the availability of the digital data 12b. For instance, the media file 12a, when played back, displays information of the digital data 12b or relevant web resources, and/or prompts the viewer to tune-in from his personal mobile device to the network coupling device 14 to access the digital data 12b or relevant web resources. The digital data 12b or the relevant web resources may comprise an interactive component to prompt for user input from an external device 50. If an user input from the external device 50 is received, the digital data 12b or relevant web resources is updated according to the user input from the external device 50, and the interactive component of digital data 12b or relevant web resources transmits commands to the processor 11 to update the media file 12a being displayed on the display device 13 accordingly.

The network coupling device 14 allows at least one external device 50, such as a personal mobile device, to couple to the processor 11 of data distribution system 10 via wireless network. The network coupling device 14, for instance, can be realized with a wireless access point, a Bluetooth peripheral device, etc.

An extended variation on the basic system is to allow the user's mobile device to gain access to a set of restricted resources on the internet. In this scenario, the computer must be connected to the internet and running software (such as a network packet filter or a HTTP proxy) that scans every network packet sent by user's mobile device. If the packet destination is for the local storage, then access is allowed. If the packet destination is to the open internet, then the packet filter checks to see if the user is trying to browse the web matching an URL pattern, such as destinations within the advertiser's product website, to decide whether access is allowed. If not, the filtering software sends and HTTP response to redirect user's mobile device to a local web page that instructs user to access what is available locally.

The processor 11 comprises a set of instruction codes to direct requests from the external device 50. The processor 11 directs the external device 50 to access the local resources such as digital data 12b, or to access internet according to the requests received from the external device 50. The processor 11 is able to control data transmitted between the processor 11 and the internet according to a predetermined rule. For instance, the processor 11 restricts internet access to predetermined web pages only, according to a list of allowable content. When at least one external device 50 is coupled to the data distribution system 10, the processor 11 can grant internet access to the external device 50 and filters certain content, so the external device 50 can only access specific information (e.g. web sites allowed by the processor 11) via the internet access provided by the data distribution system 10. According to different user requests, when an external device 50 is coupled to data distribution system 10, the processor 11 can also direct the external device 50 to access the digital data 12b stored in the storage device 12.

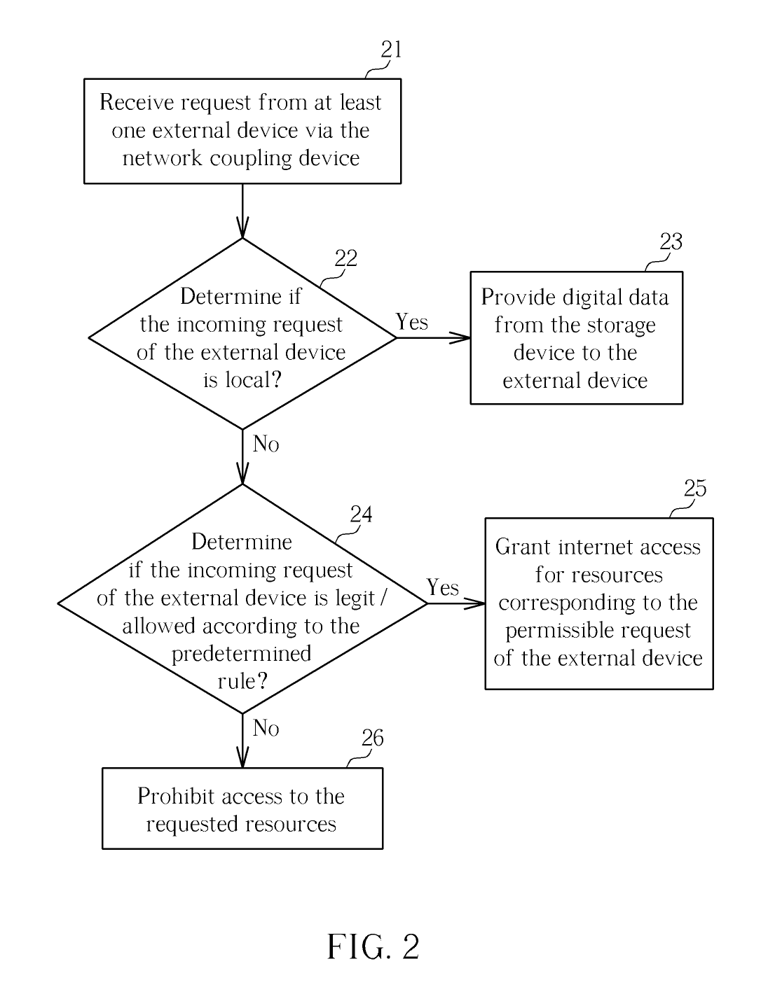

Please refer to FIG. 2. FIG. 2 is a flow chart illustrating a data distribution method utilizing data distribution system 10 according to an embodiment of the present invention. The steps of the data distribution method are described as follows:

Step 21: Receive request from at least one external device 50 via the network coupling device 14;

Step 22: Determine if the incoming request of the external device 50 is local; if so, proceed to Step 23, otherwise proceed to Step 24;

Step 23: Provide digital data 12b from the storage device 12 to the external device 50;

Step 24: Determine if the incoming request of the external device 50 is legit/allowed according to the predetermined rule set by the instruction codes of the processor 11; if so, proceed to Step 25, otherwise proceed to Step 26;

Step 25: Grant internet access for resources corresponding to the permissible request of the external device 50;

Step 26: Prohibit external device 50 from accessing the requested resources via the data distribution system 10.

Assuming the external device 50 requests to access a webpage through the local service; in Step 21, the external device 50 couples to the data distribution system 10 through the network coupling device 14, and the data distribution system 10 receives the HTTP (Hypertext Transfer Protocol) request from the external device 50. Since the external device 50 requests to access a webpage, the processor 11 verifies that the URL (Uniform Resource Locator) corresponding to the HTTP request from the external device 50 does not direct to a local drive, and proceeds to Step 24. In Step 24 if the processor 11 determines that the webpage requested is allowable content from the local service, then in Step 25 the processor grants internet access and directs the external device 50 to the desired webpage. Since the processor 11 controls internet access according to a list of allowable/disallowable content, unnecessary bandwidth consumption can also be prevented.

A technology that enables the above-mentioned filtering is by executing an HTTP proxy software on the processor. The proxy would intercept every HTTP request from user's device and decide whether to provide up-to-date content or redirect user to a different web page to present to user local resources available.

Furthermore, the basic system can be extended to allow the user to interact with the local screen attached to the computer. For example, user may arrive at a local HTML page that contains JavaScript code, which upon user clicking certain user interface elements, sends instructions to the local computer to change the content displayed on screen. Such techniques can be implemented to facilitate local user participating in voting, providing shopping tips, sharing of usage experience, etc.

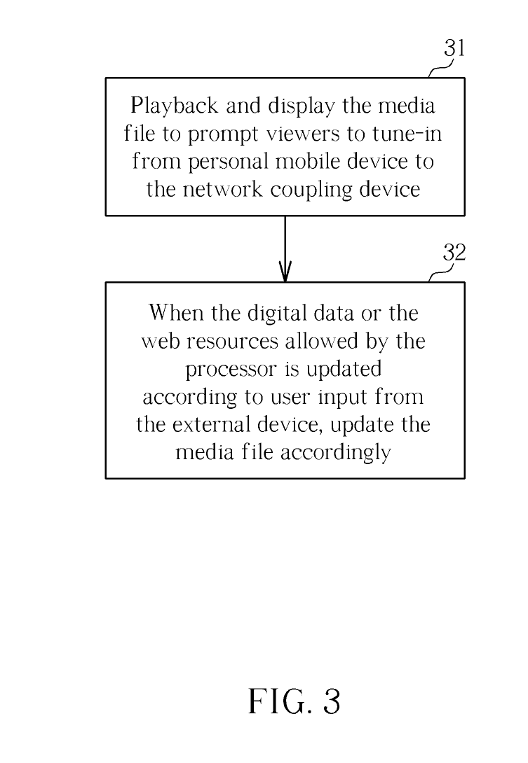

Please refer to FIG. 3. FIG. 3 is a flow chart illustrating user interacting with the data distribution system 10 according to an embodiment of the present invention. The steps of user interaction with the data distribution system are described as follows:

Step 31: Playback and display the media file 12a to prompt the viewer to tune-in from his personal mobile device to the network coupling device 14;

Step 32: When the digital data 12b or the web resources allowed by the processor 11 are updated according to user input from the external device 50, update the media file 12a according to the updated digital data 12b or the web resources allowed by the processor 11.

The digital data 12b or the relevant web resources may involve participation of the user. In this case, the display device 13 displays the media file 12a to attract users for participation. The user uses the external device 50 to couple to the data distribution system 10 to access digital data 12b or relevant web resources. Once coupled, the interactive component of digital data 12b or the relevant web resources prompts user input from the external device 50. When a user input from the external device 50 is received, the processor 11 updates digital data 12b or relevant web resources accordingly, and the interactive component of digital data 12b or relevant web resources then transmits commands to the processor 11 to update the media file 12a being displayed on the display device 13, so the media file 12a displayed is always up-to-date with the digital data 12b or relevant web resources.

One way to achieve the interoperability is by pushing a web page containing JavaScript into user's mobile device. The script can then notify the processor by accessing an URL managed by the processor when the user selects a certain object on the web page.

This way, local services may offer events that involve live interaction with the users at the venue through the data distribution system 10. For instance, local services may invite the users at the venue to couple to live websites for participating events such as live voting, surveys, puzzles, contests etc. Accordingly the progress/result of the event is updated and displayed simultaneously.

The data distribution system 10 is preferably deployed in public venues such as shopping malls, transit stations, food courts etc., so media file 12a displayed can be viewed by a mass crowd notifying the availability of information or event offered by the local services. Media file 12a displayed also serves the purpose to prompt the viewers to couple to the data distribution system 10, so viewers with mobile devices can access information provided by the location-based services via wireless networking (e.g. via network coupling device 14). Information provided by the location-based services includes on-sale information, discount coupons, floor guides, special event information, collectible digital items, etc.

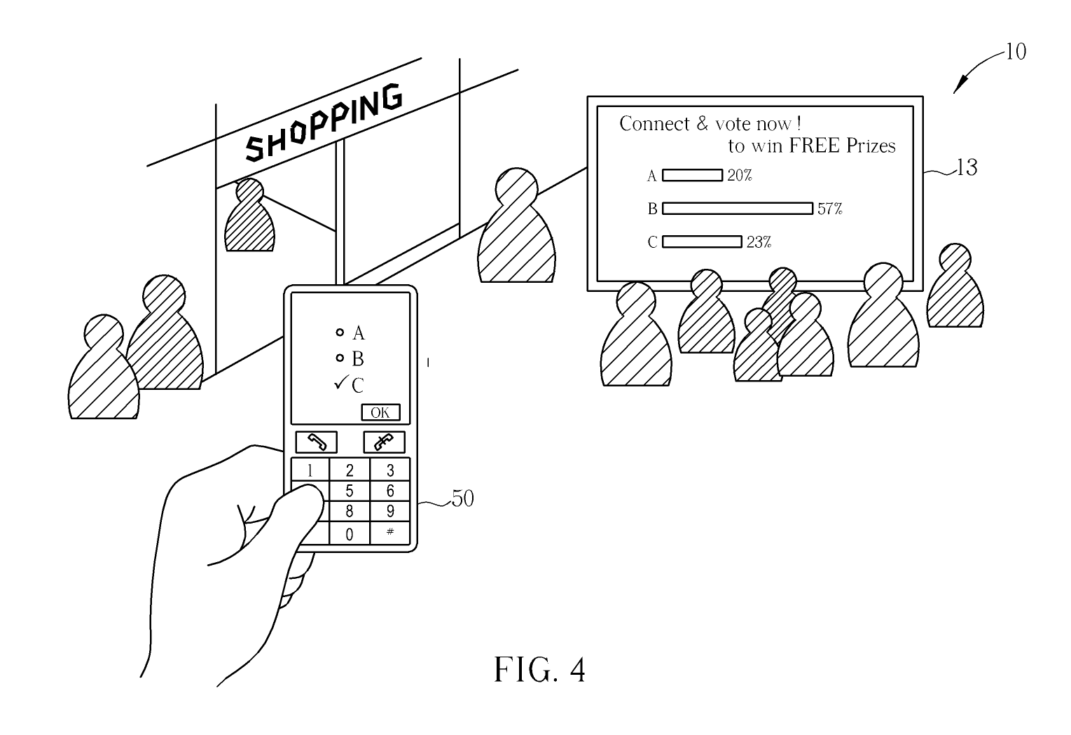

Please refer to FIG. 4. FIG. 4 is a diagram illustrating a practical embodiment utilizing the data distribution system 10 of the present invention. As shown in FIG. 4, the data distribution system 10 is deployed in a shopping mall. The location-based service provider is holding a live vote of options A, B and C, and offers prizes for participants. The display device 13 displays the relevant information (e.g. displays the media file 12a) of the voting event, and prompts viewers to couple to participate. The display device 13 also displays the live result of the voting event. A viewer sees this event on the display device 13 and utilizes his mobile device (e.g. the external device 50) to couple through the wireless access point (e.g. the network coupling device 14). The processor 11 of the data distribution system 10 directs the user to the webpage of the voting event where the user can vote. After the user completes voting, the data distribution system 10 updates the voting data (i.e. the digital data 12a) and the result displayed on the display is simultaneously updated.

Other than the mentioned WiFi+JavaScript example, a number of similar technologies can be used. For example, the network coupling device may feature Bluetooth instead of WiFi, and allows the user to download an iPhone or Android app instead of visiting a web page containing JavaScript for interactivity. These and future technologies would achieve similar results and are within the scope of this invention.

In conclusion, the present invention provides a data distribution system which informs the user availability of location-based services and allows user to access or interact with location-based services. This way, the user is provided with the up-to-date information regarding location-based services, without having to frequently/continuously check for the location-based services.

Those skilled in the art will readily observe that numerous modifications and alterations of the device and method may be made while retaining the teachings of the invention.

What is claimed is:

1. A data distribution system for distributing digital data comprising:
a processor;
a storage device, coupled to the processor for storing a media file and the digital data;
a display device, coupled to the processor, for playing back the media file; and
a network coupling device, coupled to the processor, for allowing at least one external device to connect to the processor to access the digital data.

2. The data distribution system of claim 1, wherein the processor provides internet access and a set of instruction codes to restrict the internet access according to a predetermined rule.

3. The data distribution system of claim 1, wherein the digital data comprises an interactive component for transmitting commands to the processor to update the media file being displayed on the display device.

4. The data distribution system of claim 1, wherein the media file, when played back, informs an availability of the digital data.

5. A data distribution method for distributing digital data from a data distribution system, the data distribution system comprising a processor, a storage device coupled to the processor for storing a media file and digital data, a display device coupled to the processor and a network coupling device coupled to the processor, the method comprising:
playing back the media file on the display device for informing an availability of the digital data; and
at least one external device coupling to the processor via the network coupling device for accessing the digital data from the storage device.

6. The method of claim 5, further comprising:
providing the digital data according to a user request via the network coupling device.

7. The method of claim 5, further comprising:
transmitting commands to the processor to update the media file being played back on the display device according to an interactive component of the digital data.

8. The method of claim 5, further comprising:
the processor providing internet access; and
the processor utilizing a set of instruction codes to restrict the internet access.

9. The method of claim 8, wherein the processor utilizing the set of instruction codes to restrict the internet access is the processor utilizing the set of instruction codes to allow access only a predetermined set of web pages via the internet access.

10. The method of claim 5, further comprising:
the processor utilizing a set of instruction codes to direct requests from the at least one external device.

11. The method of claim 10, wherein the processor utilizing a set of instruction codes to direct requests from the at least one external device is the processor utilizing a set of instruction codes to direct the at least one external device to access the digital data, or to access internet.
